(19) United States
(12) Patent Application Publication
(10) Pub. No.: US 2010/0156067 A1
(43) Pub. Date: Jun. 24, 2010

(54) METHOD OF PRODUCING A TOP LAYER

(75) Inventors: Helmut Holzer, St. Johann (AT); Georg Klausner, St. Johann (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: ATOMIC AUSTRIA GMBH, Altenmarkt im Pongau (AT)

(21) Appl. No.: 12/643,183

(22) Filed: Dec. 21, 2009

(30) Foreign Application Priority Data
Dec. 23, 2008 (AT) GM 749/2008

(51) Int. Cl. A63C 5/00; B32B 38/04

(52) U.S. Cl. 280/610; 156/252

(57) ABSTRACT

The invention relates to a method of producing a top layer (10) constituting a layer (6) of a gliding device (1), which top layer (10) comprises an external face (18) and an internal face (24) directed towards a core (9) of the gliding device (1). The top layer (10) is provided with at least one hole (20) extending between the external face (18) and the internal face (24). Prior to making the hole (20) through the top layer (10), an adhesive layer (23) is applied to it on the internal face (24) facing away from the external face (18), at least in the region where the hole (20) is to be made, and the hole (20) is made jointly both through the top layer (10) and through the adhesive layer (23).

### BACKGROUND OF THE INVENTION

The invention relates to a method of manufacturing a top layer for a gliding device and a gliding device incorporating such a top layer.

Document DE 20 2004 019 895 U1 discloses a snow gliding board with a gliding layer and an external face formed by a top decorative and protective element. The decorative and protective element is decorated on at least one of its faces and has one or more holes. An inner structure forming a core is enclosed by at least one inner reinforcement impregnated with resin, which is disposed underneath the top decorative and protective element. A barrier film of light-permeable or transparent polymer is also provided, at least in the region between the holes and the resin-impregnated reinforcement, the dimensions of which are bigger than the dimensions of the holes or the arrangement of holes. The barrier film also has holes, which are penetrated by resin from the impregnated reinforcement during the joining process, thereby producing a knoll inside the hole, which imparts an aesthetic effect.

Document DE 200 18 778 U1 discloses a gliding board designed for surfing on snow. In order to improve grip, cut-outs are provided in a longitudinal edge region of the top protective layer, which are of the same thickness as the protective layer. The cut-outs are made by cutting into the protective layer before the elements forming the board are placed in the casting mold. To this end, the protective layer may be processed by machine or clinched. One advantage obtained as a result of this technique is that one and the same casting mold can be used to produce boards with a smooth top face or a top face incorporating cut-outs. During the joining process, there is a risk that surplus adhesive material may penetrate the cut-outs.

### BRIEF SUMMARY OF THE INVENTION

The underlying objective of this invention is to propose a method of producing a top layer with at least one hole extending through it for a gliding device, whereby the top layer can be easily processed during the operation of joining it to the gliding device.

This objective is achieved by the invention on the basis of the approach defined by the characterizing features of claim 1. The advantage obtained as a result of the characterizing features defined in claim 1 resides in the fact that the adhesive layer is applied to the top layer on the internal face designed to produce a bond, at least in the region where the hole will be produced, and the hole is not made until the adhesive layer has been applied and set, and is formed jointly in a single work process through both the top layer and the adhesive layer. This results in a bonding region on the internal face designed for producing a bond, which is limited exclusively to the surface portions surrounding the hole which are coated with the adhesive. Also as a result, no adhesive is left in the cross-section of the hole during the joining process through to obtaining the finished gliding device and there is therefore no risk of soft adhesive getting into the hole and closing it up. This is particularly crucial if using pressure molds because this avoids creating additional mess and means that there is no need for subsequent cleaning processes. Production reliability is improved as a result and susceptibility to disruptions as well as maintenance work are significantly reduced. The hole or holes is or are used to improve the grip of the gliding device, which needs to be improved or increased in particular in the case of smooth surfaces, in order to enhance comfort when it is being carried. However, this also obviates the need for additional mutual orientation operations in situations where the top layer and the adhesive layer incorporating co-operating holes are made separately. As a result, a clean adhering process is obtained in the region of the hole and the adhesive extends as far as the circumference of the hole and terminates at it in order to produce a better seal. The entire operation of processing such a top layer during the production process is therefore improved because top layers can be pre-coated with the adhesive layer and, depending on the chosen pattern or disposition of holes, these can then be formed and made jointly through the two materials.

An approach as defined by the characterizing features specified in claim 2 is also of advantage because in spite of the large number of holes produced, a perfect bonding operation is achieved by the adhesive layer applied to the internal face. Furthermore, not only does this mean that special gripping zones can be produced, it also offers an additional visual design option. Increasing the number of holes also results in a reduction in weight, especially in the case of thicker or higher density top layers.

Another advantageous approach is defined in claim 3, whereby a cut for producing the hole can be made more cheaply and above all more cleanly. Additional advantages can be obtained on the basis of the combination of materials chosen, depending on the chosen punching direction, be it from the top layer through to the adhesive layer or vice versa.

Another variant of the method defined in claim 4 is also of advantage because subsequent coating processes can be dispensed with and the top layer can be processed to obtain the completed gliding device once the holes have been made, without the need for other finishing operations.

Another approach based on the characterizing features defined in claim 5 is of advantage because the adhesive layer can be applied to the internal face of the top layer in advance, after which the bonding process can proceed in a known manner.

Another advantageous approach is defined in claim 6, whereby excessive thermal stress to the material of the top layer can be avoided.

Another advantageous approach is defined in claim 7, whereby the bonding process can proceed without the need for additional adhesive layers and an exclusive bond is produced only on those surfaces coated with the adhesive, excluding the holes.

Another variant of the method defined in claim 8 offers advantages because the holes disposed in the top layer in conjunction with the other layer joined to it not only enable a stable bond to be obtained but also offer the possibility of a visual design defining the overall appearance of the gliding device.

Finally, the objective of the invention can be achieved on the basis of the characterizing features defined in claim 9. The advantages obtained as a result of the combination of features defined in this claim reside in the fact that a gliding device can be produced which, in spite of having an arrangement of holes in the top layer, can be easily and reliably processed. This approach obviates the need for additional coating processes and mutual orientation steps in the region of the top layer and adhesive layer, which not only leads to a perfect bonding result but also means that an attractive visual appearance can be imparted to the entire gliding device, including in the region of the hole or holes.

### BRIEF DESCRIPTION OF THE DRAWING

To provide a clearer understanding of the invention, it will be described in more detail with reference to the appended drawings.

These are highly schematic, simplified diagrams showing the following:

FIG. 1 is a highly simplified plan view, out of proportion, of a board-type gliding device, in particular a ski, with a three-dimensionally structured top face and a schematically indicated binding unit;

FIG. 2 is a highly simplified, schematic diagram showing the gliding device illustrated in FIG. 1 in cross-section along line II-II indicated in FIG. 1;

FIG. 3 is a highly simplified plan view, out of proportion, illustrating a board-type gliding device, in particular a snowboard with a three-dimensionally structured top face and a schematically indicated binding unit;

FIG. 4 is a diagram illustrating a detail from the cross-sectional diagram of FIG. 2 but on a larger scale.

### DETAILED DESCRIPTION

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

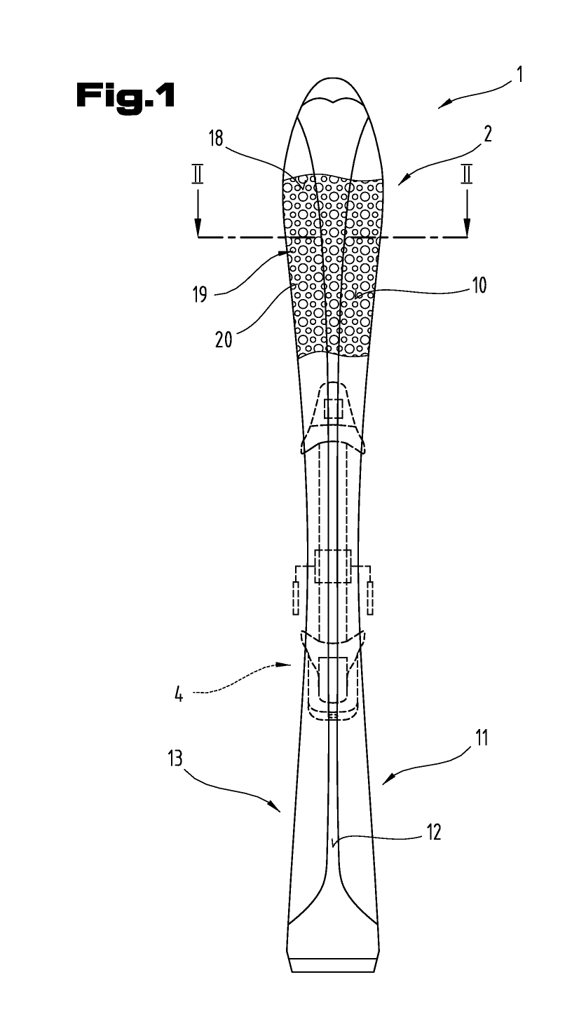

FIGS. 1 to 4 illustrate two embodiments of board-type gliding devices 1 for gliding on ice, snow or some other appropriate surface. In particular, the illustrated gliding devices 1 are designed as sports devices for practicing different types of winter sports, such as alpine skiing, cross-country skiing or snowboarding.

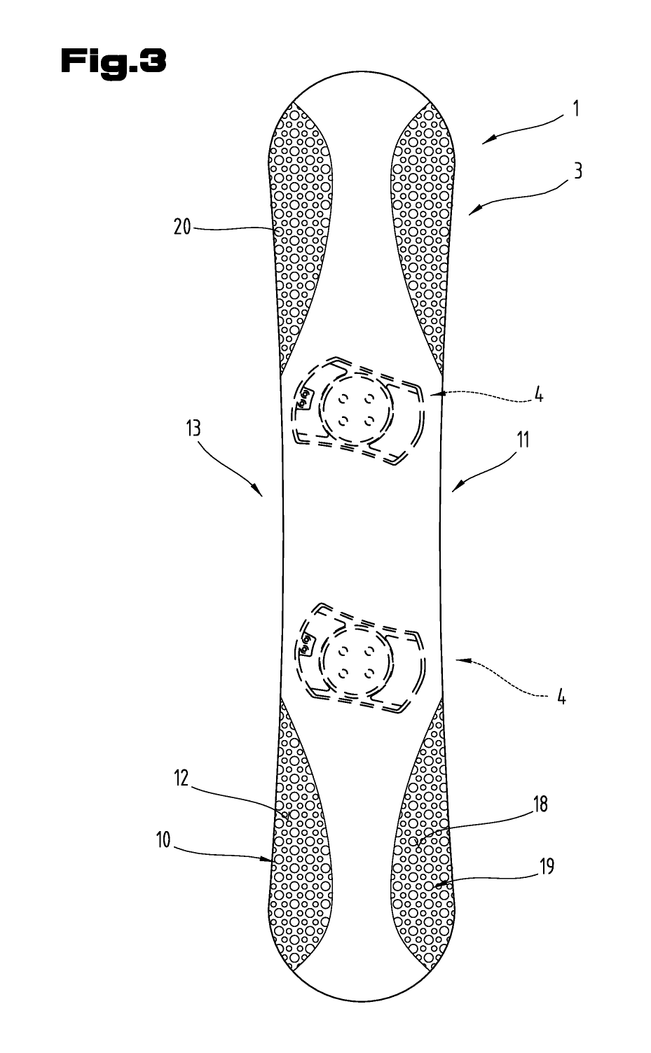

FIG. 1 illustrates one possible embodiment of a ski 2, whereas the embodiment illustrated in FIG. 3 represents one possible design of a snowboard 3. The ski 2 may also be what is known as a cross-country ski. Schematically indicated by broken lines on these gliding devices 1 is a generally standard binding unit 4 for releasably connecting the gliding device 1 to a user's shoe or foot as and when necessary.

In a manner known per se, a gliding device 1 of this type is formed by a multi-layered sandwich element 5, made up of individual layers 6, 7, 8 joined to one another non-positively and/or positively, in particular bonded, and a layer or ply more or less at the centre has the biggest cross-sectional dimension compared with the outer layers and thus forms the so-called core 9 of the sandwich element 5. The core 9 may be made from wood, in particular several bonded plies joined to one another to form an integral component, preferably made from hardwood. It is also possible for the core 9 of the gliding device 1 to be made from a foamed plastic and/or profiled elements of lightweight metal, carbon or such like.

Layers 6 and/or 7 and/or 8 disposed in the outer peripheral region of the cross-section of the gliding device 1 therefore constitute the so-called top and/or bottom belt of the sandwich element 5 or gliding device 1. These layers 6, 7, 8 are made from materials with a relatively high tensile strength and may be selected from the group comprising metals, such as aluminum, titanium, resin-impregnated woven fabrics, plastics, and are crucial in terms of defining the mechanical properties of the gliding device 1, in particular the bending stiffness and/or breaking strength. In this respect, it would be possible to use any combination of different materials for the individual layers 6, 7, 8.

The outermost layer 6 in the embodiment illustrated as an example is a top layer 10 of the gliding device 1. This uppermost top layer 10 is preferably made from plastic and primarily fulfils a decorative and protective function for the gliding device 1. Alternatively, however, the top layer 10 might also be made from metal, in particular lightweight metal such as aluminum, titanium or similar for example. The top layer 10 preferably extends in a cap-type arrangement from a first longitudinal side region 11 across a top face 12 of the gliding device 1 to the other longitudinal side region 13 of the gliding device 1. Instead of opting for the design based on a cap-type top layer 10, however, it would also be possible for the top layer 10 to extend within the region of the top plane of the gliding device 1 only, in which case the so-called side edges of the gliding device 1 are provided as separate components, preferably of plastic.

Disposed on a bottom face 14 of the gliding device 1 facing away from the top face 12 is a running surface layer 15, intended for gliding over the ground underneath, such as ice or snow, for example. The running surface layer 15 is usually made from a plastic with as low a frictional resistance to snow or ice as possible and a sufficient resistance to scratching. The peripheral regions of the running surface layer 15 or gliding device 1 are usually bounded by sharp-edged elements 16, 17 with a relatively high hardness, for example made from steel. These sharp-edged elements 16, 17 thus form steel edges for guiding the gliding device 1 exactly and without slipping on ice or snow.

It is also of advantage if at least one external face of the top layer 10 facing away from the core 9 has an at least partially structured surface 19. This three-dimensionally structured surface 19 may be formed by a plurality of holes 20 or perforations

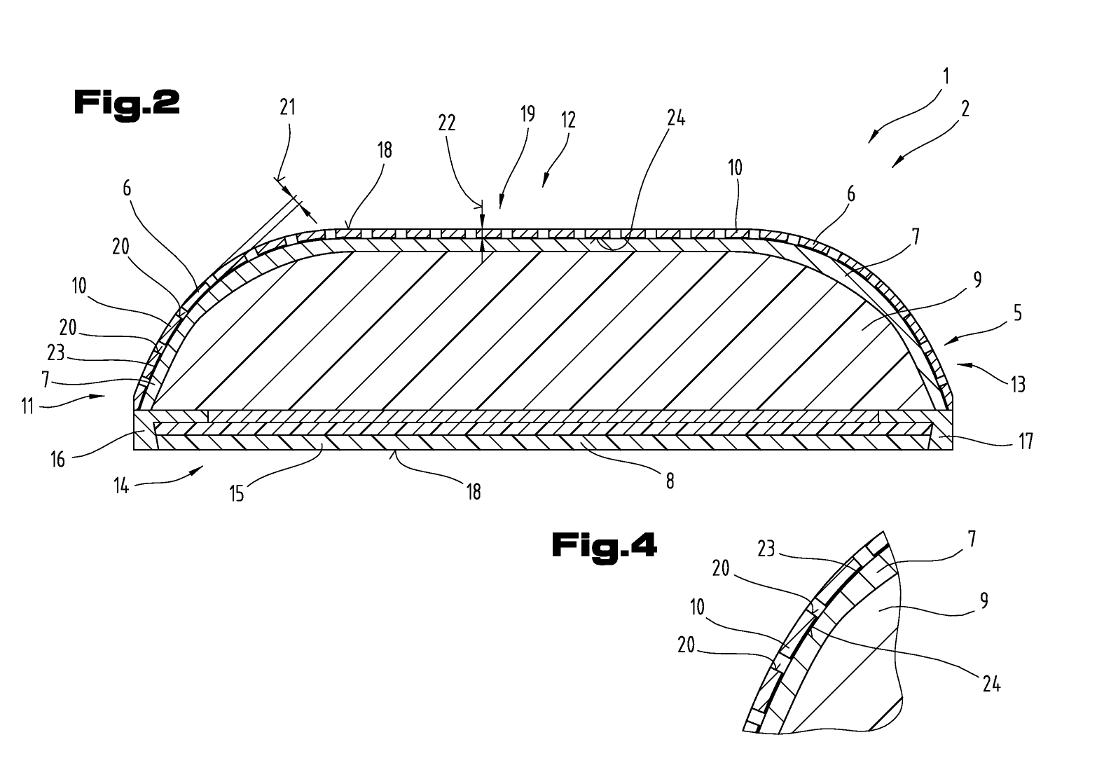

As may best be seen from FIG. 2, the holes 20 are disposed in and extend through the outermost top layer 10 of the gliding device 1 exclusively. In this respect, a depth 21 of the holes 20 corresponds respectively to a maximum thickness 22 or depth of the top layer 10. Thin lacquer or decorative films and/or thin-layered films which reduce the adhesion of ice or snow may also be provided on this top layer 10, although these are not specifically illustrated.

The purpose of the holes 20 is to improve grip when carrying the gliding devices and thus reduce or totally prevent any unintentional slipping when the gliding devices are being carried by the top layer 10. This being the case, depending on the cross-section of the holes 20, either the human skin or alternatively a glove if one is being worn is able to penetrate at least certain regions, thereby imparting better grip to the usually smooth surface, thereby facilitating handling of the gliding devices 1. The layer 6 constituting the top layer 10 is usually a relatively thin layer or a film. To provide a clearer illustration, however, the thickness 22 is illustrated on a disproportionately large scale.

It has proved to be of practical advantage to provide holes 20 which, when seen in plan view as illustrated in FIG. 1 or 3, have a surface dimension or cross-section within a lower limit of approximately 0.5 mm², preferably 1 mm², and an upper limit of 8 mm², preferably 3 mm². The surface density, i.e. the number of holes 20 per surface unit, may easily be varied depending on the intended use and cross-sectional size. The area where they are applied in the top layer 10 may also be different from that illustrated in the two examples. This offers a way of significantly influencing the intended, attractive overall appearance or visual effect of the gliding device 1. In particular, the holes 20 as such may no longer be perceptible when viewed from a greater distance if they are of a very small design, although they will not then be as practical. The grip on the gliding devices 1 is also reduced at the intended points.

A structured top layer 10 of this type with differing patterns of holes 20 specifically imparts an attractive appearance to the gliding device 1. Irrespective of this, however, it would also be possible to make lettering by arranging the holes 20 accordingly and by using a material for the layer 7 disposed underneath or below of a different color from the material of the top layer 10.

The outermost layer 6 constituting the top layer 10 is shown with an over-exaggerated thickness 22, and the thickness 22 usually varies within the film thickness range of between 0.5 mm and 2.0 mm. In order to join the layer 6 serving as the top layer 10 to the other layer 7 disposed underneath it, an adhesive layer 23 indicated by a thicker line is provided. This adhesive layer 23 is preferably an adhesive which is activated by heat. Such adhesives are also referred to in the industry as so-called “hot melt” adhesives. The adhesive may also be activated by applying pressure and this may be combined with the process of applying heat mentioned above.

FIG. 4 illustrates a detail on a larger scale of the mutually joined layers 6, 7 and the adhesive layer 23 joining them and the core 9. As may be seen from the enlarged, schematic diagram, the adhesive layer 23 is interrupted in the region of the holes 20. This prevents excessive adhesive from being able to get into the hole or holes 20 during the process of bonding to the layer 7 disposed underneath and at least partially filling them, whilst on the other hand offering a way of providing an unobstructed or non-clouded view through the hole or holes 20 to the layer 7 disposed underneath. Precisely in the case of thin-walled top layers 10, a situation can quite easily occur in which the hole or holes 20 become at least partially filled. It is of advantage to provide a free view through the hole or holes 20 to the surface of the other layer 7 joined to it by the adhesive layer 23 if the layer 7 is made from a material of a different color from that of the top layer 10, since this enables an additional visual effect to be achieved. The holes 20 could then be used to depict a company logo, lettering or similar, for example.

In this respect, the procedure adopted is to apply the adhesive layer 23 to an internal face 24 of the layer 6 forming the top layer 10 facing away from the external face 18 and designed to be bonded to the layer 7 disposed underneath, at least in the region where the hole 20 is to be made. The adhesive layer 23 is preferably applied to the full surface of the entire internal face 24. A variety of methods may be used for this purpose. For example, a spraying process, lamination with an adhesive film or alternatively a simple coating process would be conceivable. If the heat-activatable adhesive layer 23 is to be joined to the layer 6, the holes 20 are made jointly both through the layer 6 and through the adhesive layer 23. This may be done by a punching and/or cutting process, for example, in which case both the material of the top layer 10 as well as that of the adhesive layer 23 is removed from the region of the hole holes 20 together in a single work step. Depending on the chosen pattern and layout of the holes 20 with respect to one another, a perforated layer 6 and top layer 10 are formed which, on their surface intended for bonding, namely the internal face 24, are provided with the adhesive layer 23 likewise incorporating holes 20.

In order to join the layer 6 and top layer 10 prepared in this manner and incorporating at least one but preferably several holes 20 to the layer 7 disposed underneath, they may optionally be cut to size and/or made ready to suit the gliding device 1 to be produced prior to the bonding process, after which the bonding operation may be carried out in a press or similar, for example.

For the joining process, the layer 6 constituting the top layer 10 is heated in a manner known per se to the degree that the adhesive layer 23 disposed on the internal face 24 remote from the external face 18 also melts and forms a stable and strong connection to the layer 7 after the cooling process. Due to the fact that the adhesive layer 23 is also interrupted in the region of the hole or holes 20, the layer 6 is bonded exclusively in only the regions disposed between the holes 20 and in the region or portion surrounding the hole 20. In this respect, a plurality of preferably different holes 20 may be distributed or disposed across the entire surface of the top layer 10, in which case the adhesive layer 23 is disposed around the holes 20 and between them.

During this joining process in the past, the two layers 6, 7 have usually been bonded by means of a film-type adhesive layer which can be activated by heat but which is disposed across the entire surface. During the joining process, when the adhesive layer was activated accordingly, adhesive in the region of the hole 20 was also melted and was able to penetrate the hole 20, thereby at least partially closing it. The disadvantage of this is that not only is the grip lost in the region of the top layer 10, which is usually very thin, the visual appearance is also detrimentally affected or even lost altogether.

The embodiments illustrated as examples represent possible variants of the design and disposition of the top layer 10, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the top layer 10 and the gliding device 1 incorporating it, they and their constituent parts are illustrated to a certain extent out of scale and/or on an enlarged scale and/or on a reduced scale.

The objective underlying the independent inventive solutions may be found in the description.

1. A method of producing a top layer constituting a layer of a gliding device such as a ski or a snowboard, whereby the top layer comprises an external face and an internal face which can be directed towards a core of the gliding device and is provided with at least one hole extending between the external face and the internal face, wherein prior to making the hole in the top layer, an adhesive layer is applied to it on the internal face facing away from the external face, at least in the region where the hole is to be made, and the hole is made both through the top layer and through the adhesive layer jointly.

2. The method according to claim 1, wherein a plurality of holes are made through the top layer and through the adhesive layer.

3. The method according to claim 1, wherein the at least one hole is made by a punching process.

4. The method according to claim 1, wherein the adhesive layer is applied to the full surface of the entire internal face before making the at least one hole through the top layer and adhesive layer.

5. The method according to claim 1, further comprising applying heat to activate the adhesive layer.

6. The method according to claim 1, further comprising applying pressure to activate the adhesive layer.

7. The method according to claim 1, further comprising placing another layer on the side of the top layer facing away from the external face and on the adhesive layer, to which the top layer is bonded by means of the adhesive layer.

8. The method according to claim 7, wherein the other layer is made from a material of a different color from that of the top layer.

9. A gliding device such as a ski or a snowboard, with a top layer comprising an external face and an internal face directed towards a core of the gliding device, the top layer including a hole extending between at least the external face and the internal face, wherein the top layer is produced by the method according to claim 1.
